(19) United States
(12) Patent Application Publication
(10) Pub. No.: US 2006/0055804 A1
(43) Pub. Date: Mar. 16, 2006

(54) Picture taking device

(75) Inventors: Takahisa Arai, Asaka-shi (JP); Akira Mizuyoshi, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/226,397

(22) Filed: Sep. 15, 2005

(30) Foreign Application Priority Data
Sep. 16, 2004 (JP) 2004-270060

(51) Int. Cl. H04N 5/222

(52) U.S. Cl. 348/333.01

(57) ABSTRACT

The present invention provides a picture taking device comprising: an image storage device which stores image; an image information code generation device which generates an image information code by encoding at least one of accessory information attached to the image data and shooter information stored in advance; and a display device which displays the image data and the image information code. The picture taking device displays the image information code together with the image data. A person can receive a URL of a Web sire to which the image data is uploaded or an E-mail address of a picture taker by taking an image of the displayed image information code corresponding to the image data. In this way, image data of a large volume can be easily distributed to a large number of destinations.

### BACKGROUND OF THE INVENTION

1. Field of the Invention

The present invention relates to a picture taking device.

2. Related Art

In recent years, techniques have been developed to utilize character information such as uniform resource locators (URLs), electronic mail addresses and telephone numbers by recording the information in a two-dimensional bar code. For example, Japanese Patent Application Laid-Open No. 2003-198674 discloses a portable telephone terminal having a digital camera portion for taking an image of a subject and forming image data on the image, and a signal processing device which can be connected to the Internet, and which obtains character information by performing signal processing on image data on characters or a two-dimensional bar code imaged by the digital camera portion. In this portable telephone terminal, the facility with which character information is input is improved because of use of a two-dimensional bar code.

### SUMMARY OF THE INVENTION

In a case where a photograph (a photograph of a group of persons, a snapshot or the like) is taken during a travel or the like by using a picture taking device and prints of the photograph are distributed from the person possessing the picture taking device (shooter) to persons having their photograph taken, a substantially long time is taken to complete the distribution process including printing. The portable telephone terminal disclosed in Japanese Patent Application Laid-Open No. 2003-198674 is capable of easily inputting URLs and electronic mail addresses and, therefore, capable of sending and receiving sending image data through the Web and electronic mail. However, sending and receiving image data is time consuming if the size of the image data is large, or if the image data is taken as a picture of a substantially large number of persons and distributed to the persons.

In view of the above-described circumstances, an object of the present invention is to provide a picture taking device capable of easily distributing a large-size image data to a large number of destinations.

To achieve the above-described object, according to a first aspect of the present invention, there is provided a picture taking device including an image storage device which stores an image data, an image information code generation device which generates an image information code by encoding at least one of accessory information attached to the image data and shooter information stored in advance, and a display device which displays the image data and the image information code.

The picture taking device of the first aspect displays the image data and the image information code corresponding to the image data. A person can receive a URL of a Web site to which the displayed image information code corresponding to the desired image data. Therefore, the person can obtain the desired image data via the received URL and the like. In this way, the image data can easily be distributed, and image data of a large volume can easily be distributed to a large number of destinations.

According to a second aspect of the present invention, the accessory information in the picture taking device according to the first aspect includes at least one of the date of picture taking by which the image data is obtained, the condition of picture taking, GPS information, a file name, a file format and an image size, and the shooter information includes at least one of a URL, an electronic mail address and a telephone number of the shooter.

According to the third aspect of the present invention, the image storage device in the picture taking device according to the first or second aspect stores the image information in association with the image data.

The picture taking device according to the third aspect enables the image data and the image information code corresponding to the image data to be immediately read, since there is no need to generate the image information code each time the image data is regenerated.

According to a fourth aspect of the present invention, the picture taking device according to any one of the first to third aspects further includes an information input device which inputs the shooter information.

Shooter information can be directly input to the picture taking device according to a fourth aspect.

According to a fifth aspect of the present invention, the image information code in the picture taking device according to the any one of the first to fourth aspects is a two-dimensional bar code.

According to the present invention, the image information code in which the shooter information and the accessory information (exchangeable image file format (EXIF) tag information) is displayed together with the image data. A person can receive a URL of a Web site to which the image data is uploaded or an E-mail address of a picture taker by taking an image of the displayed image information code corresponding to the desired image data. Thus easily distributing a URL of a Web page to which the image data is uploaded or an electronic mail address of the shooter. In this way, image data of a large volume can be easily distributed to a large number of destinations.

### BRIEF DESCRIPTION OF THE DRAWINGS

FIG. 1 is a block diagram showing a picture taking device according to an embodiment of the present invention;

FIG. 2 is a flowchart showing a method of registering shooter information;

FIG. 3 is a flowchart showing a method of generating an image information code;

FIG. 4 is a flowchart showing a method of distributing image data; and

FIG. 5 is a plan of a display 22 when image data is distributed.

### DETAILED DESCRIPTION OF THE PREFERRED EMBODIMENTS

A picture taking device according to a preferred embodiment of the present invention will be described with reference to the accompanying drawings.

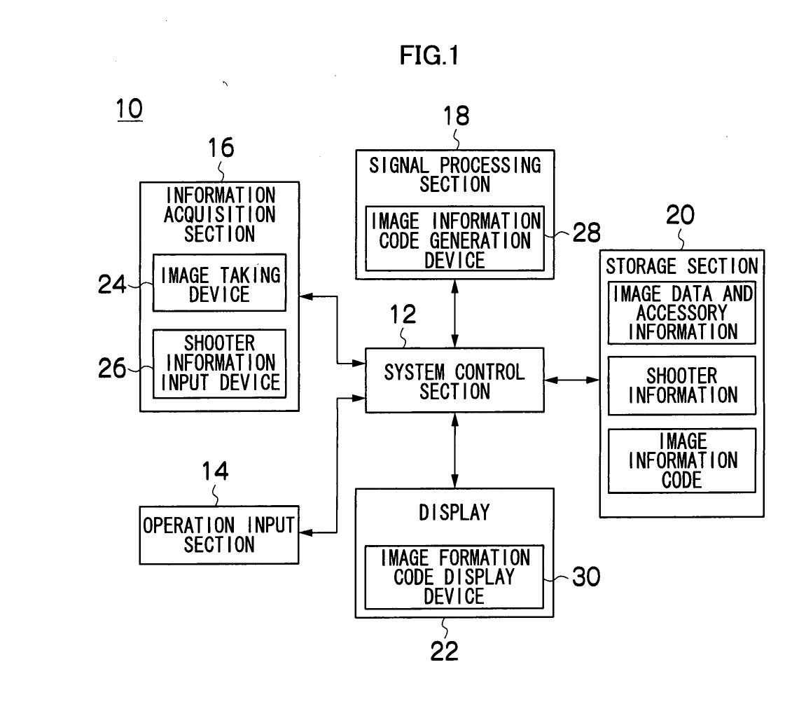

FIG. 1 is a block diagram showing a picture taking device 10 according to an embodiment of the present invention. The picture taking device 10 shown in FIG. 1 has a system control section 12, an operation input section 14, an information acquisition section 16, a signal processing section 18, a storage section 20 and a display 22.

The operation input section 14 is a block including operation input devices such as a release switch and various setting buttons.

The information acquisition section 16 has an image taking device 24 and a shooter information input device 26. The image taking device 24 includes an optical system through which a subject is imaged, and image pickup device and other components. The shooter information input device 26 is a device for inputting personal information about a shooter (e.g., a URL for a Web page, an electronic mail address and a telephone number of the shooter, hereinafter referred to as shooter information). Examples of devices usable as the shooter information input device 26 are a key input device such as a keyboard, a device (optical character reader (OCR)) which, when an image of a paper sheet or the like on which shooter information is described is taken by the image taking device 24, analyzes the image and converts the image into text data, and a device which inputs shooter information by taking an image of a two-dimensional code or the like (quick response (QR) code) in which the shooter information is recorded. To enable input of such shooter information, a personal computer or the like of a shooter and the picture taking device 10 may be connected to each other.

The signal processing section 18 is a block for processing information obtained through the information acquisition section 16. In the signal processing section 18, image data taken by the image taking device 24 is converted into a predetermined format. The signal processing section 18 has an image information code generation device 28 which encodes the above-described shooter information and accessory information attached to image data. The accessory information is, for example, EXIF tag information attached to image data and including the date and condition of picture taking by which the image data is obtained, global positioning system (GPS) information (in the case of a camera having the GPS function), a file name, a file format and an image size.

The storage section 20 is a block in which shooter information input through the shooter information input device 26 and an image information code generated by the image information code generation device 28 are stored as well as image data and information accessory to the image data. The storage section is, for example, a flash memory or memory card incorporated in the picture taking device 10.

The display 22 is a monitor (e.g., a liquid crystal display (LCD) monitor) used as an electronic finder for checking the filed angle at the time of picture taking and used to display a preview image for a taken image and to regenerate image data or the like read out from the storage section 20. The display 22 includes an image information code display device 30 for displaying an image information code.

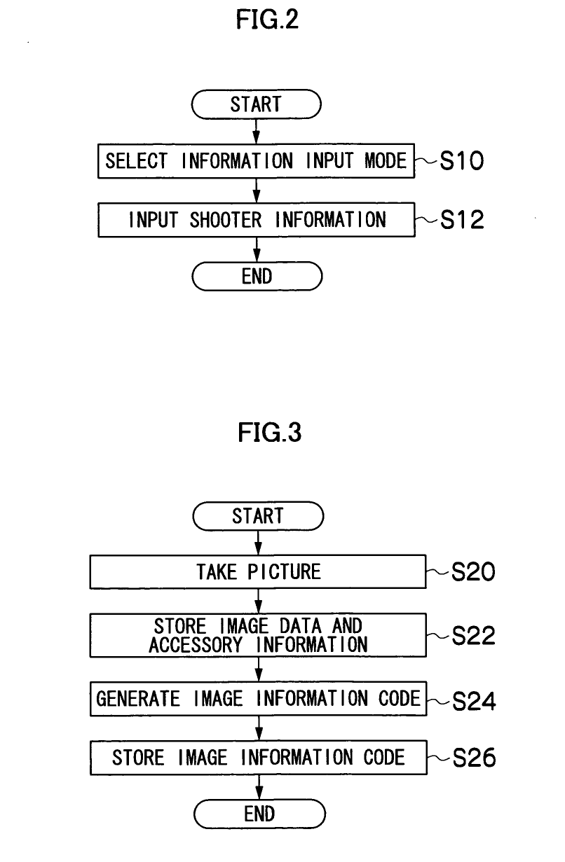

A method of registering shooter information in the picture taking device 10 will be described. FIG. 2 is a flowchart showing a method of registering shooter information.

First, a shooter operates the operation input section 14 to select an information input mode in which the picture taking device 10 registers shooter information (step S10). Next, shooter information is input by the shooter information input device 26 and stored in the storage section 20 (step S12). The shooter information (e.g., an URL for a Web page, an electronic mail address and a telephone number of the shooter) is thereby registered in the picture taking device 10.

A method of generating an image information code will be described. FIG. 3 is a flowchart showing a method of generating an image information code.

First, picture taking is performed by the picture taking device 10 to obtain image data (step S20). Accessory information (e.g., the date and condition of picture taking by which the image data is obtained, GPS information (if a camera having the GPS function), a file name, a file format and an image size) attached to the image data is stored in the storage section 20 together with the image data (step 22). Subsequently, the shooter information registered in advance in the picture taking device 10 and the information accessory to the image data are encoded by the image information code generation device 28, thereby generating an image information code (step S24). This image information code is stored in the storage section 20 by being associated with the image data (step S26). The image information code in which the shooter information and the information accessory to the image data are recorded is thus generated.

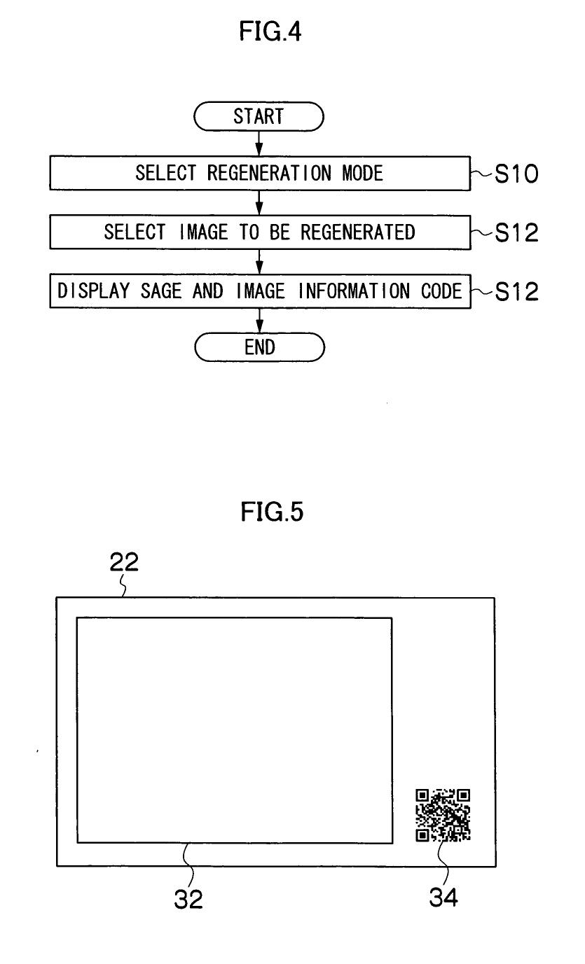

A method of distributing image data obtained by the picture taking operation of the picture taking device 10 will now be described. FIG. 4 is a flowchart showing a method of distributing image data.

The shooter first operates the operation input section 14 to select a regeneration mode in which the picture taking device 10 regenerates image data obtained by picture taking on the display 22 (step S30). When an image to be regenerated is selected (step S32), the selected image and the image information code corresponding to this image are displayed on the display 22 (step S34).

FIG. 5 is a plan view of the display 22 when image data is distributed. As shown in FIG. 5, an image information code 34 is displayed on the display 22 together with image data 32 to be presented to distribution destinations (e.g., persons having their image taken in image data 32 or persons accompanying the shooter). Subsequently, the image information code 34 is imaged by terminals such as digital cameras or portable telephones with cameras at the distribution destinations. The image information code 34 is analyzed by the terminals at the destinations or personal computers or the like connected to the terminals and a URL for a Web page of the shooter is thereby read to enable access the Web page of the shooter. The shooter uploads the image data 32 to the Web page before the Web page is accessed, thus making it possible to easily distribute the image data even if the volume of the image data is large or if the number of distribution destinations is large.

The URL recorded in the image information code 34 may be a URL for the top page in Web pages of the shooter or an URL including the full path to the image data. If the full path to the image data is used, a path to the image data on the Web may be automatically generated on the basis of the file name in the information accessory to the image data.

While distribution of image data 32 through a Web page of the shooter has been described, image data 32 may be distributed, for example, as a file attached to pieces of return mail sent in response to pieces of electronic mail sent from distribution destinations to the electronic mail address of the shooter recorded in image information code 34.

While a QR code is used as image information code 34, this embodiment is not limited to use of such a code. For example, a one-dimensional bar code or a two-dimensional bar code may alternatively be used.

What is claimed is:

1. A picture taking device comprising:
an image storage device which stores an image data;
an image information code generation device which generates an image information code by encoding at least one of accessory information attached to the image data and shooter information stored in advance; and
a display device which displays the image data and the image information code.

2. The picture taking device according to claim 1, wherein the accessory information includes at least one of the date of picture taking, the condition of picture taking, GPS information, a file name, a file format and an image size of the image data, and the shooter information includes at least one of a URL, an electronic mail address and a telephone number of the shooter.

3. The picture taking device according to claim 1, wherein the image storage device stores the image information code in association with the image data.

4. The picture taking device according to claim 2, wherein the image storage device stores the image information code in association with the image data.

5. The picture taking device according to claim 1, further comprising an information input device which inputs the shooter information.

6. The picture taking device according to claim 2, further comprising an information input device which inputs the shooter information.

7. The picture taking device according to claim 3, further comprising an information input device which inputs the shooter information.

8. The picture taking device according to claim 4, further comprising an information input device which inputs the shooter information.

9. The picture taking device according to claim 1, wherein the image information code is a two-dimensional bar code.

10. The picture taking device according to claim 2, wherein the image information code is a two-dimensional bar code.

11. The picture taking device according to claim 3, wherein the image information code is a two-dimensional bar code.

12. The picture taking device according to claim 4, wherein the image information code is a two-dimensional bar code.

13. The picture taking device according to claim 5, wherein the image information code is a two-dimensional bar code.

14. The picture taking device according to claim 6, wherein the image information code is a two-dimensional bar code.

15. The picture taking device according to claim 7, wherein the image information code is a two-dimensional bar code.

16. The picture taking device according to claim 8, wherein the image information code is a two-dimensional bar code.
